(19) United States
(12) Patent Application Publication
(10) Pub. No.: US 2008/0244759 A1
(43) Pub. Date: Oct. 2, 2008

(54) COMPUTER SYSTEM WITH ELECTRONIC LOCK AND KEYBOARD TO CONTROL THE ELECTRONIC LOCK

(75) Inventor: XIANG CAO, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD ., Shenzhen City (CN); HON HAI PRECISION INDUSTRY CO., LTD., Taipei Hsien (TW)

(21) Appl. No.: 11/829,975

(22) Filed: Jul. 30, 2007

(30) Foreign Application Priority Data
Mar. 27, 2007 (CN) 200710200333.9

(51) Int. Cl. G08B 29/00; G06F 1/26

(52) U.S. Cl. 726/34

(57) ABSTRACT

An exemplary computer system includes an input device for users to input a command therein and converting the command into a coded command; a computer chassis; a computer power supply; a power switch by which a user is capable of turning on or off the computer power supply; a code receiving module attached in the computer chassis for receiving the coded command from the input device; a decoding module connecting to the code receiving module to decode the command into a command signal; a control module connecting to the decoding module to receive the command signal, and control the power switch being enable or disable to be operated to turn on or off the computer power supply; and an electronic lock controlled by the control module to lock or unlock the chassis based on the command signal.

### BACKGROUND

1. Field of the Invention

The present invention relates to computer systems, and particularly to a computer system having an electronic lock in a chassis and a keyboard to control the electronic lock.

2. Description of Related Art

In computer systems such as personal computers (PC) systems, operators usually need to input a correct password in order to access a PC system, thereby protecting data from unauthorized access.

When a BIOS (Basic Input/Output System) performs environment setting of the PC system, the operator can input the password through a keyboard or the like. The input password is transmitted to the BIOS to release the lock status. Thereby, the BIOS controls electronic access to the hard disk or other devices in the PC system until a correct password is input.

However, there are methods to overcome this safeguard. For example, people can open the computer chassis and then discharge the complementary metal oxide semiconductor (CMOS) to eliminate the data.

What is needed, therefore, is a computer system which can solve the above problem.

### SUMMARY

An exemplary computer system comprises an input device for users to input a command therein and converting the command into a coded command; a computer chassis; a computer power supply; a power switch by which a user is capable of turning on or off the computer power supply; a code receiving module attached in the computer chassis for receiving the coded command from the input device; a decoding module connecting to the code receiving module to decode the command into a command signal; a control module connecting to the decoding module to receive the command signal, and control the power switch being enable or disable to be operated to turn on or off the computer power supply; and an electronic lock controlled by the control module to lock or unlock the chassis based on the command signal.

Other advantages and novel features will become more apparent from the following detailed description when taken in conjunction with the accompanying drawings, in which:

### BRIEF DESCRIPTION OF THE DRAWINGS

FIG. 1 is a block diagram of one embodiment of a computer system in accordance with the present invention comprising a code receiving module, a decoding module, a control module, and an electronic lock;

FIG. 2 is a circuit diagram of the code receiving module and decoding module of FIG. 1;

FIG. 3 is a circuit diagram of the control module of FIG. 1;

FIG. 4 is a circuit diagram of the electronic lock of FIG. 1; and

FIG. 5 is a block diagram of one embodiment of a keyboard in accordance with the present invention.

### DETAILED DESCRIPTION

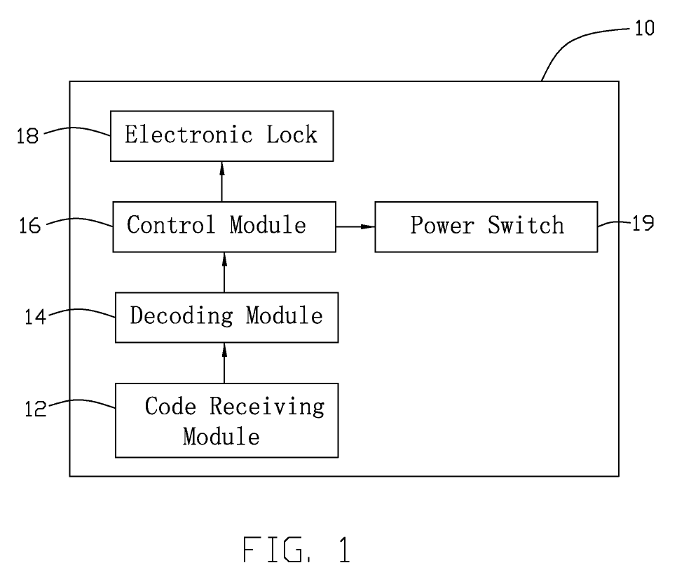

Referring to FIG. 1, a computer system in accordance with an embodiment of the present invention includes: a chassis 10, a code receiving module 12 to receive a coded password; a decoding module 14 to decode the coded password into a password signal; a power switch 19 by which a user may turn on or turn off the computer system; an electronic lock 18 to lock or unlock the chassis 10 of the computer system; and a control module 16 to control the electronic lock 18 and the power switch 19 based on the password signal.

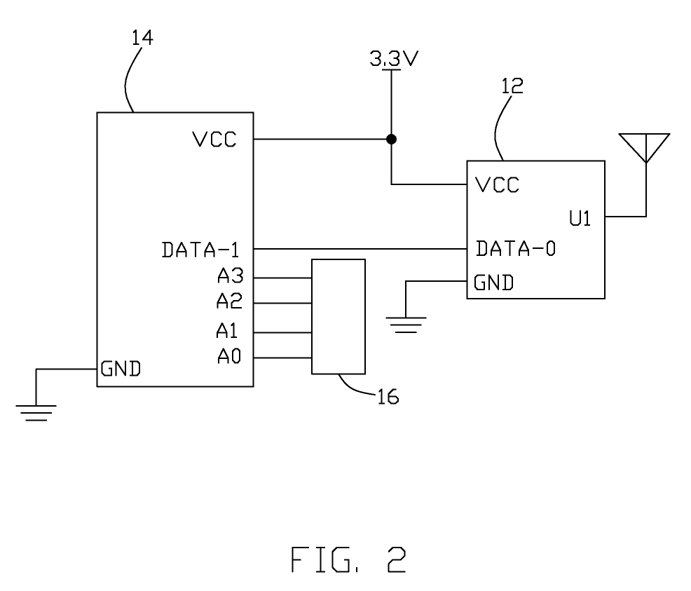

Referring to FIG. 2, the code receiving module 12 includes a long wave receiver having a data pin DATA-0, an antenna pin U1, a power pin VCC, and a ground pin GND. The antenna pin U1 is connected to a receiving antenna to receive the coded password. The decoding module 14 includes a decoder having a data pin DATA-1, a power pin VCC, a ground pin GND, and four signal pins A0˜A3 to output the password signal. The data pin DATA-1 is connected to the data pin DATA-0 of the code receiving module 12. The power pin VCC of the decoding module 14 and the code receiving module 12 are connected to a 3.3V power supply. The ground pins GND of the decoding module 14 and the code receiving module 12 are grounded.

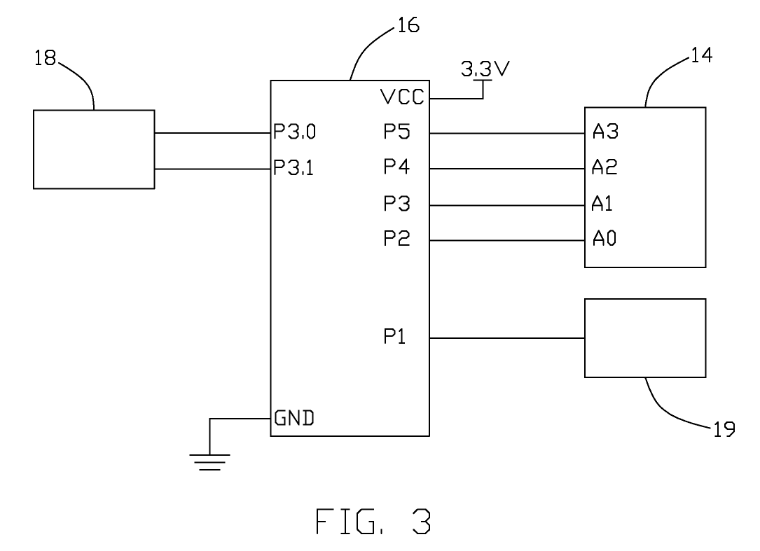

Referring also to FIG. 3, the control module 16 includes seven signal pins P1˜P5 and P3.0˜P3.1, a power pin VCC, and a ground pin GND. The signal pins P2˜P5 are connected to the corresponding signal pins A0˜A3 of the decoding module 14 respectively, and the signal pin P1 is connected to a ground terminal of the power switch 19 to control the power switch 19. The power pin VCC is connected to the 3.3V power supply, and the ground pin GND is grounded.

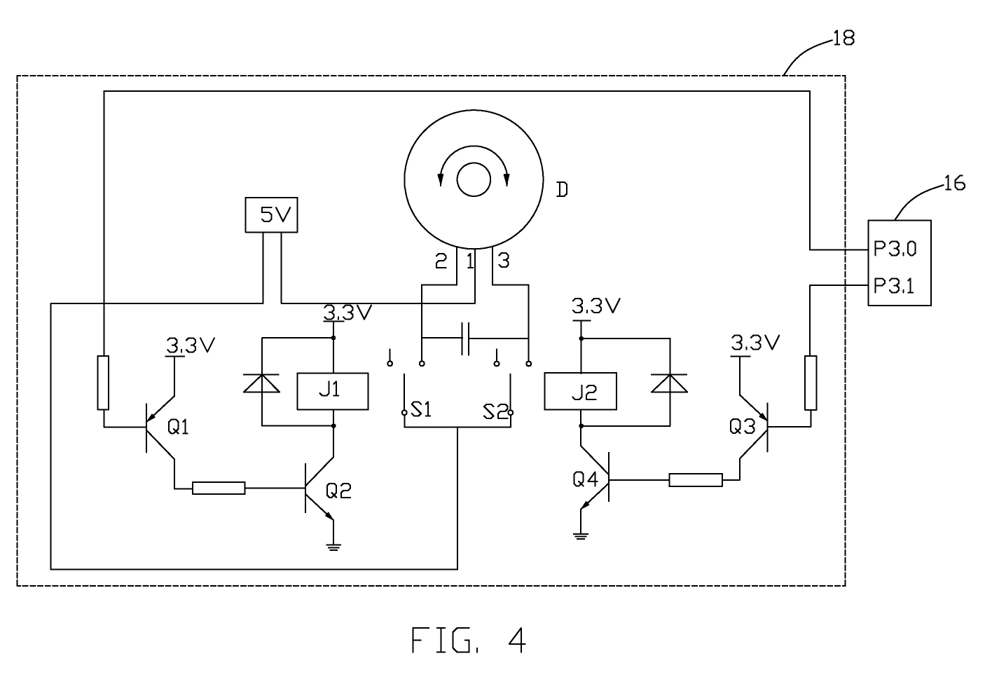

Referring also to FIG. 4, the electronic lock 18 includes a reversing motor D having three terminals 1˜3, four transistors Q1˜Q4, a first relay-switch having a relay portion J1 and a switch portion S1, and a second relay-switch having a relay portion J2 and a switch portion S2. Bases of the transistors Q1 and Q3 are connected to corresponding signal pins P3.0 and P3.1 of the control module 16 respectively. Emitters of the transistors Q1 and Q3 are connected to the 3.3V power supply. A collector of the transistor Q1 is connected to a base of the transistor Q2. A collector of the transistor Q2 is connected to the 3.3V power supply via the relay portion J1 of the first relay-switch. An emitter of the second transistor Q2 is grounded. A collector of the transistor Q3 is connected to a base of the transistor Q4. A collector of the transistor Q4 is connected to the 3.3V power supply via the relay portion J2 of the second relay-switch. An emitter of the transistor Q4 is grounded. The terminal 1 of the reversing motor D is connected to a terminal of a 5V drive power, and the terminals 2 and 3 of the reversing motor D are connected to the other terminal of the 5V drive power via corresponding switch portions S1 and S2 of the first and second relay-switches respectively.

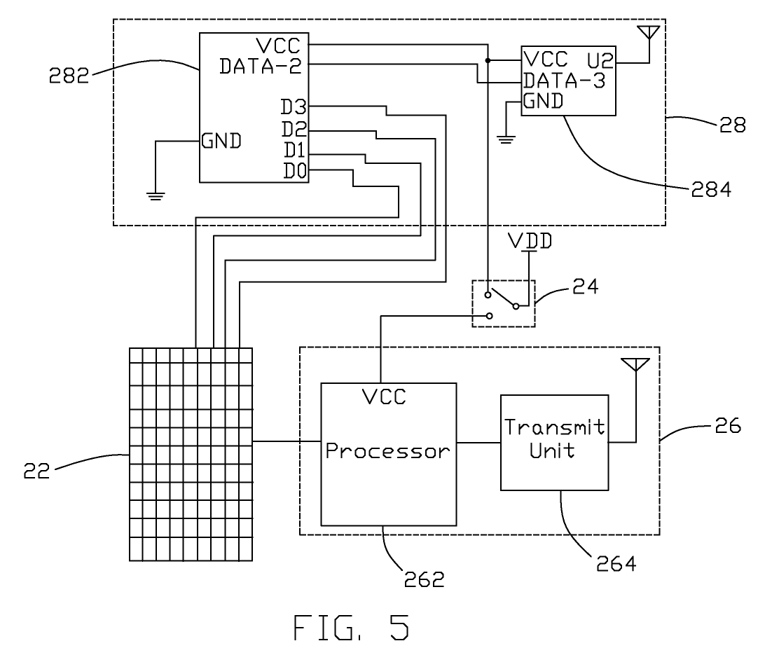

Referring to FIG. 5, a keyboard such as an ordinary keyboard used in a computer system in accordance with an embodiment of the present invention includes: a keypad module 22 being used to input a password; a password module 28 having a code module 282 to code a password signal generated by the keypad module 22 into a coded password, and a code sending module 284 to send the coded password to the code receiving module 12; a transfer module 26 to send other information input by the keypad module 22 to the computer system; a selection switch 24 to selectively connect the keypad module 22 to the password module 28 or the transfer module 26.

The code module 282 of the password module 28 includes an encoder having a power pin VCC, a data pin DATA-2, and four signal pins D0˜D3 connected to corresponding signal pins of the keypad module 22. The code sending module 284 includes a long wave transmitter having a data pin DATA-3 connected to the data pin DATA-2 of the code module 282, a power pin VCC connected to the power pin VCC of the code module 282, and an antenna pin U2 connected to a transmit antenna to send the coded password. The transfer module 26 includes a processor 262 having a power pin VCC, and a transmit unit 264. The selection switch 24 is a single-pole double-throw switch. The throws of the selection switch 24 are respectively connected to the power pins VCC of the code module 282 and the processor 262, and the pole of the selection switch 24 is connected to a power source VDD to selectively drive the transfer module 26 or the password module 28. When the selection switch 24 connects the keypad module 22 with the password module 28, unlock or lock commands can be input via the keypad module 22. When the selection switch 24 connects the keypad module 22 with the transfer module 26, the input device functions as a regular input device for the computer system and unlock or lock commands cannot be input.

In this embodiment, the signal pins P3.0 and P3.1 of the control module 16 are initially at a high level to turn off the transistors Q1˜Q4 of the electronic lock 18. Therefore, the relay-switches are turned off so the reversing motor D is off. The signal pin P1 of the control module 16 is at high level locking the power switch 19 of the computer system.

Before the computer system is started up, the operator operates the selection switch 24 of the keyboard to select a password state, and then input the password via the keypad module 22. The password module 28 receives the password signal generated by the keypad module 22 and codes it into a coded password. The password module 28 transmits the coded password to the code receiving module 12 of the computer system via the antenna pin U2 thereof. The decoding module 14 decodes the coded password into the password signal and transmits it to the control module 16. The control module 16 compares the password signal with a password previously stored in the control module 16 by the operator. Voltages of the signal pins P3.1 and P1 of the control module 16 go low if the password signal is correct. A voltage of the signal pin P3.0 remains at high. Therefore, the transistors Q3 and Q4 are turned on turning on the second relay-switch starting the reversing motor D to urge a locking mechanism of the motor (not shown) to move in a first direction for unlocking the chassis 10 of the computer system. A voltage of the ground terminal of the power switch 19 is at a low level activating the power switch 19. Therefore, the operator can turn on or off the computer system by pressing the power switch 19.

If the operator inputs a lock command, voltages at the signal pin P3.0 of the control module 16 is set low by the control module 16, and P1 of the control module 16 and the signal pin P3.1 are set high. Therefore, the transistors Q1 and Q2 are turned on turning on the first relay-switch starting the reversing motor D to urge the locking mechanism of the motor (not shown) to move in a second direction reverse to the first direction, for locking the chassis 10 of the computer system. Voltage at the ground terminal of the power switch 19 is high locking the power switch 19. Therefore, the operator cannot turn on or off the computer system by pressing the power switch 19, and cannot open the chassis 10 of the computer system.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A computer system comprising:
an input device for users to input a command therein and converting the command into a coded command;
a computer chassis;
a computer power supply;
a power switch by which a user is capable of turning on or off the computer power supply;
a code receiving module attached in the computer chassis for receiving the coded command from the input device;
a decoding module connecting to the code receiving module to decode the command into a command signal;
a control module connecting to the decoding module to receive the command signal, and control the power switch being enable or disable to be operated to turn on or off the computer power supply; and
an electronic lock controlled by the control module to lock or unlock the chassis based on the command signal.

2. The computer system as claimed in claim 1, wherein the code receiving module includes a long wave receiver having a data pin and an antenna pin connected to a receiving antenna to receive the coded command.

3. The computer system as claimed in claim 2, wherein the decoding module includes a decoder having a data pin connected to the data pin of the code receiving module and four signal pins to provide the command signal.

4. The computer system as claimed in claim 3, wherein the control module includes first to seventh signal pins, wherein the first to fourth signal pins are connected to the corresponding signal pins of the decoding module respectively, and the seventh signal pin is connected to a ground terminal of the power switch.

5. The computer system as claimed in claim 4, wherein the electronic lock includes a reversing motor having first to third terminals, first to fourth transistors, first and second relay-switches each having a relay portion and a witch portion, wherein a base of the first and third transistors are connected to the fifth and sixth signal pins of the control module respectively, an emitter of the first and third transistors are connected to a power source, a collector of the first transistor is connected to a base of the second transistor, a collector of the second transistor is connected to the power source via the relay portion of the first relay-switch, an emitter of the second transistor is grounded, a collector of the third transistor is connected to a base of the fourth transistor, a collector of the fourth transistor is connected to the power source via the relay portion of the second relay-switch, an emitter of the fourth transistor is grounded, the first terminal of the reversing motor is connected to a terminal of a drive power, and the second and the third terminals of the reversing motor are connected to the other terminal of the drive power via the switch portion of the first and second relay-switch respectively.

6. The computer system as claimed in claim 1, wherein the input device comprises:
a keypad module configured for providing a command signal corresponding to the command input by the users or other information;
a password module having a code module to code the command signal into the coded command, and a code sending module to send the coded command to the code receiving module;
a transfer module configured for sending the other information input by the keypad module to the computer system;
a selection switch selectively connecting the keypad module to the password module or the transfer module.

7. The computer system as claimed in claim 6, wherein the code module of the password module includes a power pin, a data pin, and four signal pins connected to corresponding signal pins of the keypad module.

8. The computer system as claimed in claim 7, wherein the code sending module includes a long wave transmitter having a data pin connected to the data pin of the code module, and an antenna pin connected to a transmit antenna to send the coded command.

9. The computer system as claimed in claim 7, wherein the selection switch having three terminals, the first one of the three terminals is connected to the power pin of the code module, the second one of the three terminals is connected to a power pin of the transfer module, and the third one of the three terminals is connected to a power source to selectively drive the code module or the transfer module.

10. A computer system comprising:
an input device comprising a keypad module for a user to input a password therein and converting the password into a password signal, a password module having a code module to code the password signal into a coded password, and a code sending module for transmitting the coded password; and
a computer chassis;
a power switch by which a user is capable of turning on or off the computer system, mounted on the chassis;
a code receiving module attached in the computer chassis for receiving the coded password from the input device;
a decoding module connecting to the code receiving module to decode the password into the password signal;
a control module connecting to the decoding module to receive the password signal, and control the power switch being enable to be operated to turn on the computer system; and
an electronic lock configured to lock the chassis, connected to the control module which is capable of controlling the electronic lock to unlock the chassis based on the password signal.

11. The computer system as claimed in claim 10, wherein a lock command is capable of being input into the keypad module to allow the control module to control the electronic locking the chassis and the power switch being disable to turn on or off the computer system.

12. The computer system as claimed in claim 11, wherein the electronic lock comprises a motor with a locking mechanism which is moveable in a direction to unlock the chassis when the password is input and is moveable in a second direction to lock the chassis when the lock command is input, the second direction being opposite to the first direction.

13. The computer system as claimed in claim 11, wherein the input device further comprises a transfer module configured for sending data information other than the password and lock command, input via the keypad module, to the computer system, and a selection switch selectively connecting the keypad module to one of the password module and the transfer module.
